(19) United States
(12) Patent Application Publication
(10) Pub. No.: US 2007/0246988 A1
(43) Pub. Date: Oct. 25, 2007

(54) Adjustment structure of chair backrests

(76) Inventor: Ching-Lin Hung, Taichung City (TW)

Correspondence Address: EGBERT LAW OFFICES, 412 MAIN STREET, 7TH FLOOR, HOUSTON, TX, 77002, US

(21) Appl. No.: 11/410,165

(22) Filed: Apr. 25, 2006

(51) Int. Cl. B60N 2/02

(52) U.S. Cl. 297/353

(57) ABSTRACT

The present invention provides an adjustment structure of the chair backrest. The adjustment structure includes a sliding end of the first part of the backrest, and the guiding sliding seat of the second part of the chair backrest. A positioning component is placed on the pre-determined part of the guided sliding seat and on the assembled part of the positioning component of the guided sliding seat, which includes a controlling end and a fastening end. The controlling end can be extended out one side the guided sliding seat, and the fastening end can be extended to the zigzag positioning groove of the sliding end. There is a resilience component placed on the corresponding location of the positioning component. The new adjustment structure of the chair backrest can be simple, have high stability, and more practicality.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a chair, and more particularly to a chair that has and adjustment structure of the chair backrest.

### BACKGROUND OF THE INVENTION

Because the chair backrest of the conventional chair is fixed and unable to be adjusted according to the user's figure, the industry continues to develop structures for backrest adjustment. The conventional chair backrest adjustment has problems such as complicated components and high assembly cost.

The structure for a chair backrest has been improved continually, and a “double acting type” structure is developed. The new features of a “double acting type” backrest include the head rest adjustment, recline and upright of the head rest, and the width adjustment, upright and recline position of the main frame of the backrest, and the forward and backward adjustment of the backrest. Therefore, it offers more adjustments than a conventional backrest, and each adjustment must consider the position and the convenience of the movement, and the stability of the position. Therefore, if the conventional structure is used with this special backrest, one of the problems will be that not every adjustment can be applied. The second problem is that the cost of the manufacturing would increase dramatically, which is not practical.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The improved facts of the present invention are described as follows:

1. The adjustment structure of the chair backrest disclosed in the present invention has a sliding end 50 with zigzag positioning groove 51, a guided sliding seat 60, a positioning component 70 and a resilience component 80, which achieves the preferred practicability. The structure has simple components and greatly reduced cost, so that it can be used to adjust the head rest of the chair backrest, width of the chair backrest, and the moving forward and backward of the chair backrest.

2. The positioning is achieved by locking the peg 73 of the positioning component 70 in the zigzag positioning groove 51 to makes the positioning stable.

3. The adjustment structure of the present invention can be positioned and adjusted by pressing, moving or pushing the positioning component 70, which makes the operation effective and convenient.

The new effect of the present invention is described as follows:

By the design of the resilient support 90 between the sliding end 50 of the curved bottom frame 11 and the seat cushion 40, the sliding end 50 becomes more resilient, which makes the forwarding movement of the curved bottom frame 11 much easier.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the front angle of the preferred embodiment of the present invention.

FIG. 2 shows an assembled perspective view of the back angle of the preferred embodiment of the present invention.

FIG. 3 shows an exploded perspective view of the assembled part of the backrest of the present invention.

FIG. 4 shows a sectional view of the adjustment structure of the present invention at a positioned state.

FIG. 5 shows a sectional view of the adjustment structure of the present invention at an adjustable state.

FIG. 6 shows an elevation and sectional view of the adjustment of the backrest of the present invention.

FIG. 7 shows an exploded perspective view of the head rest of the present invention.

FIG. 8 shows another elevation and sectional view of the adjustment of the head rest.

FIG. 9 shows an exploded perspective view of the main supporting frame and a curved bottom frame.

FIG. 10 shows an elevation and sectional view of the adjustment of the main support frame of the present invention.

FIG. 11 shows an exploded perspective view of the curved bottom frame and the seat cushion of the present invention.

FIG. 12 shows an assembled perspective view of the curved bottom frame and the seat cushion.

FIG. 13 shows a bottom view of another embodiment of the positioning component and controlling end.

FIG. 14 shows another bottom view of an embodiment of the positioning component and controlling end.

FIG. 15 shows another bottom view of an embodiment of the positioning component and controlling end.

FIG. 16 shows a perspective view of the sliding end of the curved bottom frame and the guided sliding seat with pulley.

FIG. 17 shows the sectional view of the sliding end of the curved bottom frame and the guided sliding seat with pulley.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

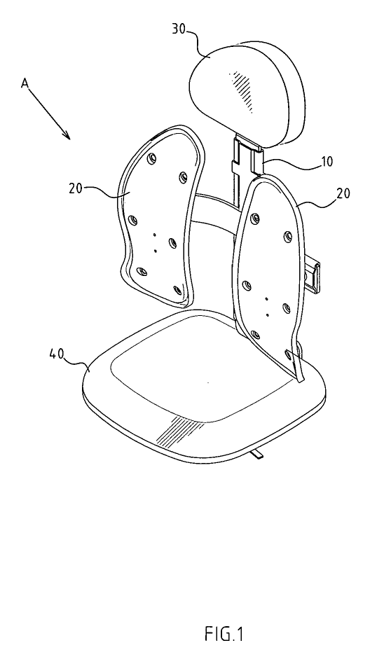

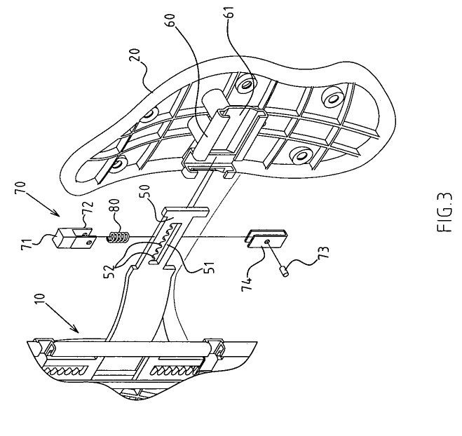

As shown in FIGS. 1-3, there is an adjustment structure of the chair backrest described in the present detailed description of the present invention based on a typical preferred embodiment. Although the invention has been explained in relation to a preferred embodiment, it is to be understood that many other possible modifications and variations can be made without departing from the spirit and scope of the invention as hereinafter claimed.

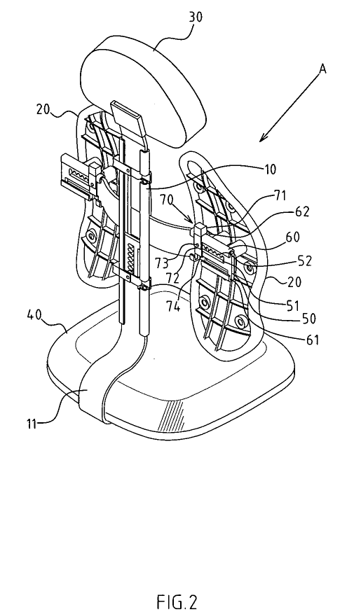

The adjustment structure of the chair backrest mentioned herein is placed on the first and second parts on the chair backrest, and the present invention uses a double-acting type chair backrest to describe that adjustment structure applied to all parts of the chair backrest. As shown in FIGS. 1 and 2, the double-acting type chair backrest A comprises a main supporting frame 10 and a left/right side panels 20, head rest 30. The bottom of the main supporting frame 10 is placed at the bottom of the seat cushion 40 by a curved bottom frame 11. The head rest 30 is placed on the top end of the main supporting frame 10. Left/right side panels 20 are placed on the left and right sides of the main supporting frame 10. The adjustment structure of the present invention can be placed on all the connecting parts of the said chair backrest A to achieve the adjusting purposes. The following describes the left/right side panels 20 that are placed on the main supporting frame 10.

The adjustment structure includes a sliding end 50 with zigzag positioning groove 51, which is placed on the main supporting frame 10 of the chair backrest A (which is the first part). The zigzag positioning groove 51 has several spaced slots 52 that are placed in the direction where the sliding end is going to slide.

A guiding seat 60 is placed at the back board 20 (which is the second part) of the chair backrest, and the guided sliding seat 60 has a sliding groove 61 for the sliding end 50 to place on and slide. An assembly part 62 of the positioning component is placed on the pre-determined part of the guided sliding seat 60, and the assembly part of the positioning component is perpendicular to the sliding groove 61 of the guided sliding seat 60.

A positioning component 70 is placed on the assembly part 62 of the positioning component of the guided sliding seat 60. The positioning component 70 includes a controlling end 71 and a fastening end 72. The controlling end 71 is on one side of the guided sliding seat 60 for operational purposes, and the controlling end of the embodiment is a press button. The fastening end 72 can be extended to the zigzag positioning groove 51 of the sliding end 50, and a peg 73 can be placed inside the corresponding slot 52.

A resilience component 80, a spring in the present embodiment, is placed on the corresponding position of the positioning component 70, so that the peg 73 of the positioning component 70 is moving toward the slot 52.

Among them, the fastening end 72 of the positioning component 70 has an U-shaped lining plate for the other side of the sliding end 50.

Through the above structure and design, the operation of the adjustment structure disclosed by the present is explained as follows:

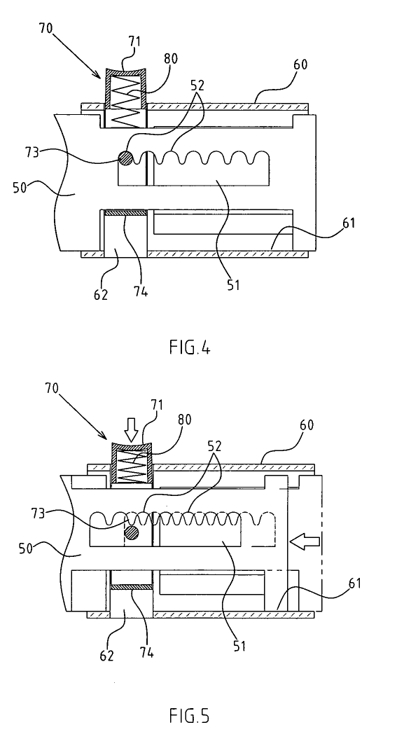

As shown in FIG. 4, the positioning component 70 is supported by the resilience component 80 under normal circumstances, locking the peg 73 of the fastening end in the slot 52. The positioning component 70 is perpendicular to the sliding end 50, which locks the sliding end 50 in and causes the sliding end 50 to be unable to slide.

As shown in FIG. 5, when the user desires to adjust the part between the sliding end 50 and the guided sliding seat 60, the user only has to press the controlling end 71 of the positioning component 70 to make the peg of the fastening come off the slot 52. Meanwhile, the resilience component 80 is pressed to accumulate the resilience. The sliding end 50 may be released, so that sliding end 50 can slide and be adjusted.

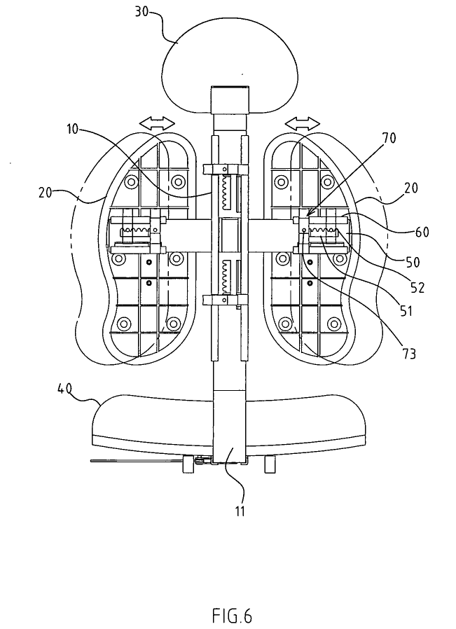

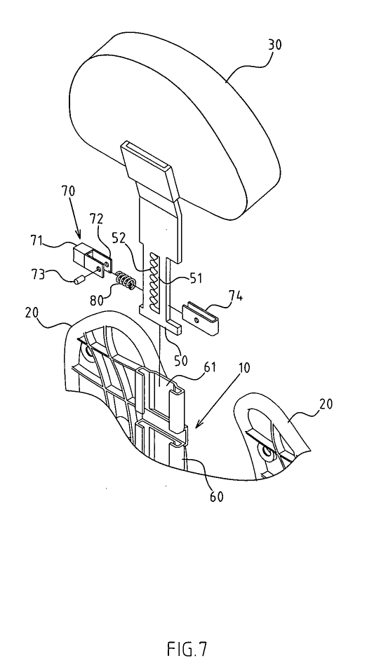

As shown in FIG. 6, left/right side panels 20 of the chair backrest A of the present invention, by operating the adjustment structure mentioned above, slide the backrest left and right, and adjust the width of the chair backrest to respond to the needs of users.

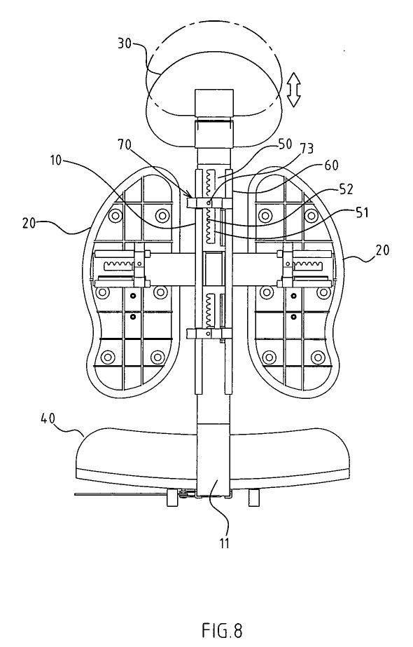

As shown in FIG. 7, there is an exploded perspective view of the head rest 30 and the main supporting frame 10 of the chair backrest A. Its structure and adjustment are the same as ones disclosed in the FIGS. 4 and 5; therefore, it is not repeated here. The adjustment of the head rest 30 is shown in FIG. 8, which is adjusted according to the height of the user's head.

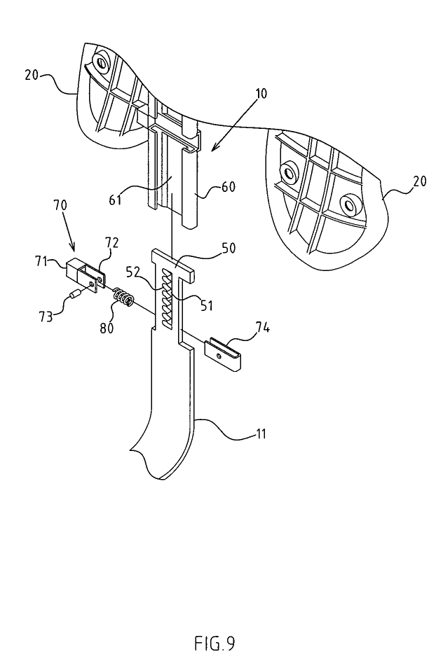

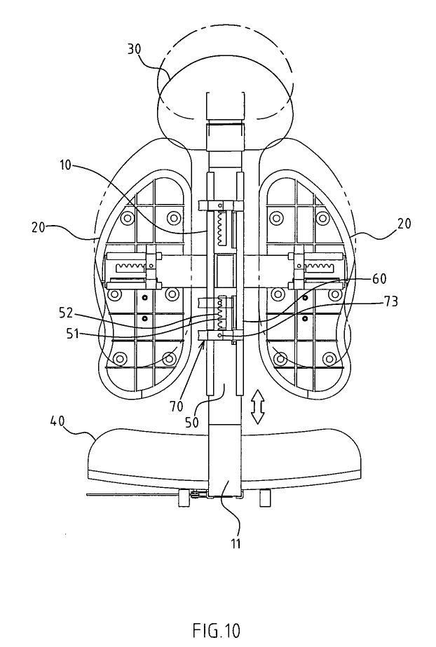

As shown in FIG. 9, there is an exploded perspective view of the main supporting frame 10 and the curved bottom frame 11 of the chair backrest A. Its structure and adjustment are the same as ones disclosed in the FIGS. 4 and 5; therefore, it is not repeated here. The adjustment of the main supporting frame 10 is shown in the FIG. 10, and when the main supporting frame 10 is sliding up and down, it can adjust the left/right side panels 20 and head rest 30 at the same time.

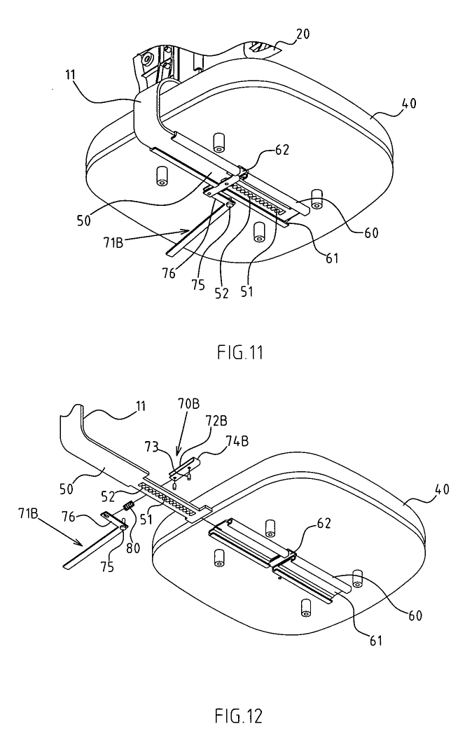

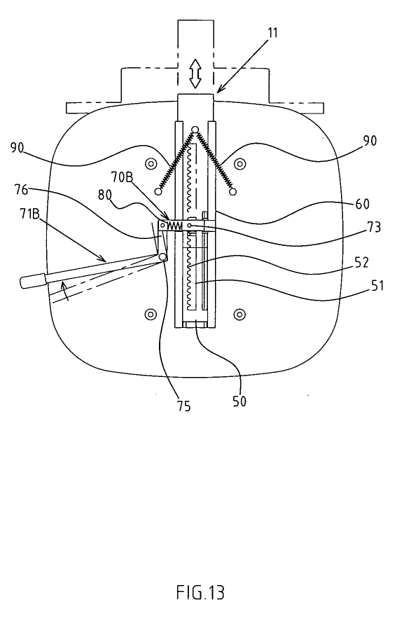

As shown in FIGS. 11, 12, there are the assembled and exploded perspective views, respectively, of the bottom of the curved bottom frame 11 and the seat cushion 40 of the chair backrest A. Its structures and adjustments are the same as ones that are disclosed in FIGS. 4 and 5, except, the positioning component 70B of the present embodiment is modified, its controlling end 71B being a movable part. The controlling end 71B of the present embodiment is a L shape, and its outer end extends out one side of the seat cushion 40 for manual operation. The curved end of the controlling end 71B is placed on the pre-determined part at the seat cushion 40 on one axle 75. Fastening end 72B of the positioning limiting plate 74B is in one piece with the U-shape limiting plate 74B. This curved end of the controlling end 71B and the fastening end 72B of the positioning component 70B is connected pivotally. By so doing, it pushes the positioning component 70B by moving the controlling end 71B (as shown in FIG. 13), to make the peg 73 come off the slot 52, and by so doing, it can adjust the front and back of the curved bottom frame 11 to move the chair backrest forward and backward.

As shown in FIG. 13, the space between the sliding end 50 of the curved bottom frame 11 and the seat cushion 40 has resilient part 90 (such as spring, and elastic rope), so that the sliding end 50 may have resilience. By so doing, it makes the forwarding movement of the curved bottom frame 11 mush easier. The resilient part can be applied to other parts mentioned above to receive the same effect.

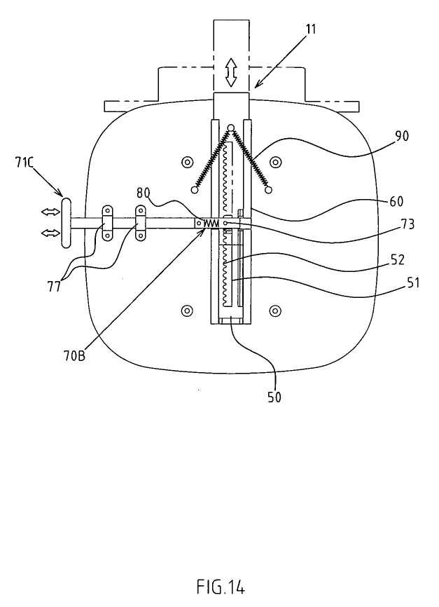

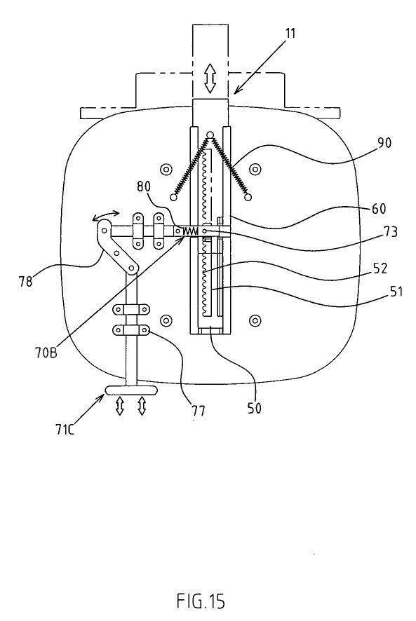

Moreover, as shown in FIG. 14, the controlling end 71C of the positioning component 70B can be a push-and-pull component. A guiding limiting component 77 can be placed at the bottom of the seat cushion 40, so that the controlling end 71C can be operated steadily. As shown in FIG. 15, which is the modified structure of the FIG. 14, the difference is that the controlling end 71C is perpendicular to the positioning component 70B, its connection being moved by a movable part 78, and by pulling and pushing of the controlling end 71C to achieve the positioning component 70B.

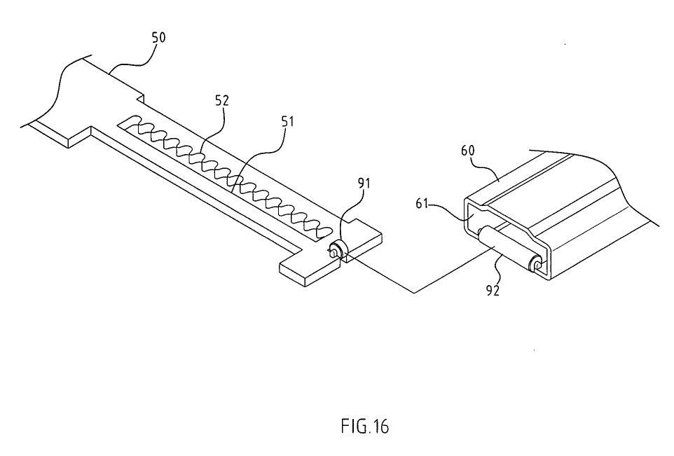

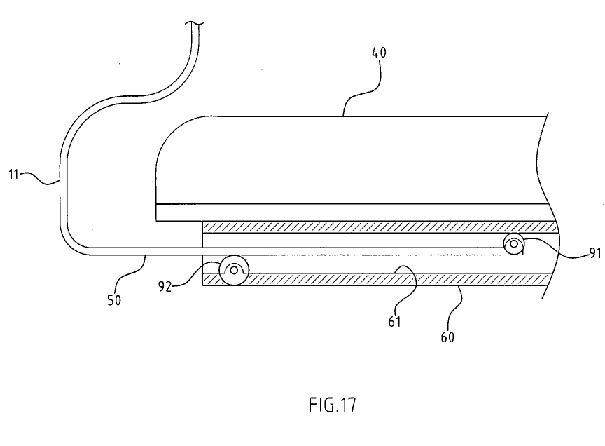

Moreover, when the adjustment structure is applied to the part where the curved bottom frame 11 of the chair backrest A and the bottom of the seat cushion 40 meet, such as shown in FIG. 16, a first pulley 91 can be placed at the end of the sliding end 50 of the curved bottom frame 11. The first pulley 91 can be pushed against the top wall of the guided sliding seat 60 of the seat cushion 40, so that a second pulley 92 can be placed on the end that the guided sliding seat 60 at the bottom of the seat cushion 40 can be placed in. The second pulley 92 is located at the bottom of sliding end 50 of the curved bottom frame 11. By so doing, as shown in FIG. 17, when the sliding end 50 of the curved bottom frame 11 is placed inside the guided sliding seat 60 of the seat cushion 40, the curved bottom frame 11 is affected by the weight of the chair backrest A (see FIG. 1), and causes the uneven pressure at the ends of the sliding end 50 and disrupts the sliding. Therefore, by adding the first pulley 91 and second pulley 92, it lifts the end of the sliding end 50 for the support of the first pulley 91, so that the sliding becomes smooth, and the pressing of the head of the sliding end 50 is made smooth by the support of the second pulley 92.

I claim:

1. An adjustment structure for a chair backrest, said adjustment structure being placed at where first and second parts of said chair backrest meet, the adjustment structure comprising:
a sliding end with zigzag positioning groove, placed on the first part of the chair backrest, said zigzag positioning groove having several spaced slots placed in a direction where said sliding end is going to slide;
a guiding seat, placed at the second part of the chair backrest, said guided sliding seat having a sliding groove for said sliding end to place on and slide and an assembly part of a positioning component placed on a pre-determined part of said guided sliding seat, said assembly part of said positioning component being perpendicular to said sliding groove of said guided sliding seat;
a positioning component, placed on said assembly part of said positioning component of said guided sliding seat, said positioning component having a controlling end and a fastening end, said controlling end being on one side of said guided sliding seat for operational purposes, said fastening end being extended to said zigzag positioning groove of said sliding end, a peg being placed inside a corresponding slot; and
a resilience component, being placed on a corresponding position of said positioning component, said peg of said positioning component moving toward said slot.

2. The structure defined in claim 1, wherein said controlling end of said positioning component being a press button.

3. The structure defined in claim 1, wherein said controlling end of said positioning component being a movable part.

4. The structure defined in claim 1, wherein said controlling end of said positioning component being a pulling part.

5. The structure defined in claim 1, wherein said fastening end of said positioning component has a U-shaped limiting plate put against another side of said sliding end of the first part.

6. The structure defined in claim 1, wherein said resilience component is a spring.

7. The structure defined in claim 1, wherein said resilient support is placed between said sliding end of the first and second parts to make said sliding end more resilient.

8. The structure defined in claim 1, the chair backrest being a double-acting type chair backrest, the chair backrest being comprised of a main supporting frame, left/right side panels, and a head rest, wherein a bottom of said main supporting frame is placed at a bottom of a seat cushion by a curved bottom frame, said head rest being placed on a top end of said main supporting frame, left/right side panels being placed on right and left sides of said main supporting frame relatively.
